(19) United States
(12) Patent Application Publication
(10) Pub. No.: US 2014/0100852 A1
(43) Pub. Date: Apr. 10, 2014

(54) DYNAMIC SPEECH AUGMENTATION OF MOBILE APPLICATIONS

(71) Applicant: PeopleGo Inc., Seattle, WA (US)

(72) Inventors: Geoffrey W. Simons, Seattle, WA (US); Matthew A. Markus, Seattle, WA (US)

(73) Assignee: PeopleGo Inc., Seattle, WA (US)

(21) Appl. No.: 14/050,222

(22) Filed: Oct. 9, 2013

Related U.S. Application Data
(60) Provisional application No. 61/711,657, filed on Oct. 9, 2012.

(51) Int. Cl. G10L 13/00

(52) U.S. Cl. CPC G10L 13/00
USPC 704/260

(57) ABSTRACT

Speech functionality is dynamically provided for one or more applications by a narrator application. A plurality of shared data items are received from the one or more applications, with each shared data item including text data that is to be presented to a user as speech. The text data is extracted from each shared data item to produce a plurality of playback data items. A text-to-speech algorithm is applied to the playback data items to produce a plurality of audio data items. The plurality of audio data items are played to the user.

### CROSS REFERENCE TO RELATED APPLICATIONS

This application claims the benefit of U.S. Provisional Application No. 61/711,657, filed Oct. 9, 2012, which is incorporated by reference in its entirety.

### BACKGROUND

1. Field of Art

This disclosure is in the technical field of mobile devices and, in particular, adding speech capabilities to applications running on mobile devices.

2. Description of the Related Art

The growing availability of mobile devices, such as smartphones and tablets, has created more opportunities for individuals to access content. At the same time, various impediments have kept people from using these devices to their full potential. For instance, a person may be driving or otherwise situationally impaired, and it could be unsafe or even illegal for them to view content. Another example would be of someone suffering from a visual impairment due to a disease process, which might prevent them from reading content. A known solution to the aforementioned impediments is the deployment of Text-To-Speech (TTS) technology in mobile devices. With TTS technology, content is read aloud so that people can use their mobile devices in an eyes-free manner. However, existing systems do not enable developers to cohesively integrate TTS technology into their applications. Thus, most applications currently have little to no usable speech functionality.

### BRIEF DESCRIPTION OF DRAWINGS

The disclosed embodiments have advantages and features that will be more readily apparent from the detailed description, the appended claims, and the accompanying figures (or drawings). A brief introduction of the figures is below.

FIG. 1 is a block diagram of a speech augmentation system in accordance with one embodiment.

FIG. 2 is a block diagram showing the format of a playback item in accordance with one embodiment.

FIG. 3 is a flow diagram of a process for converting shared content into a playback item in accordance with one embodiment.

FIG. 4A is a flow diagram of a process for playing a playback item as audible speech in accordance with one embodiment.

FIG. 4B is a flow diagram of a process for updating the play mode in accordance with one embodiment.

FIG. 4C is a flow diagram of a process for skipping forward to the next playback item available in accordance with one embodiment.

FIG. 4D is a flow diagram of a process for skipping backward to the previous playback item in accordance with one embodiment.

FIG. 5 illustrates one embodiment of components of an example machine able to read instructions from a machine-readable medium and execute them in a processor to provide dynamic speech augmentation for a mobile application.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Described herein are embodiments of an apparatus (or system) to add speech functionality to an application installed on a mobile device, independent of the efforts by the developers of the application to add speech functionality. Embodiments of a method and a non-transitory computer readable medium storing instructions for adding speech functionality are also described.

In one embodiment, an application (referred to herein as a “narrator”) receives one or more pieces of shared content from a source application (or applications) for which speech functionality is desired. Each piece of shared content comprises textual data, with optional fields such as subject, title, image, body, target, and/or other fields as needed. The shared content can also contain links to other content. The narrator converts the pieces of shared content into corresponding playback items that are outputted. These playback items contain text derived from the shared content, and thus can be played back using Text-To-Speech (TTS) technology, or otherwise presented to an end-user.

In one embodiment, the narrator is preloaded with several playback items generated from content received from one or more source applications, enabling the end-user to later listen to an uninterrupted stream of content without having to access or switch between the source applications. Alternatively, after the narrator receives shared content from an application, the corresponding newly created playback item can be immediately played. In this way, the narrator dynamically augments applications with speech functionality while simultaneously centralizing control of that functionality on the mobile device upon which it is installed, obviating the need for application developers to develop their own speech functionality.

### System Overview

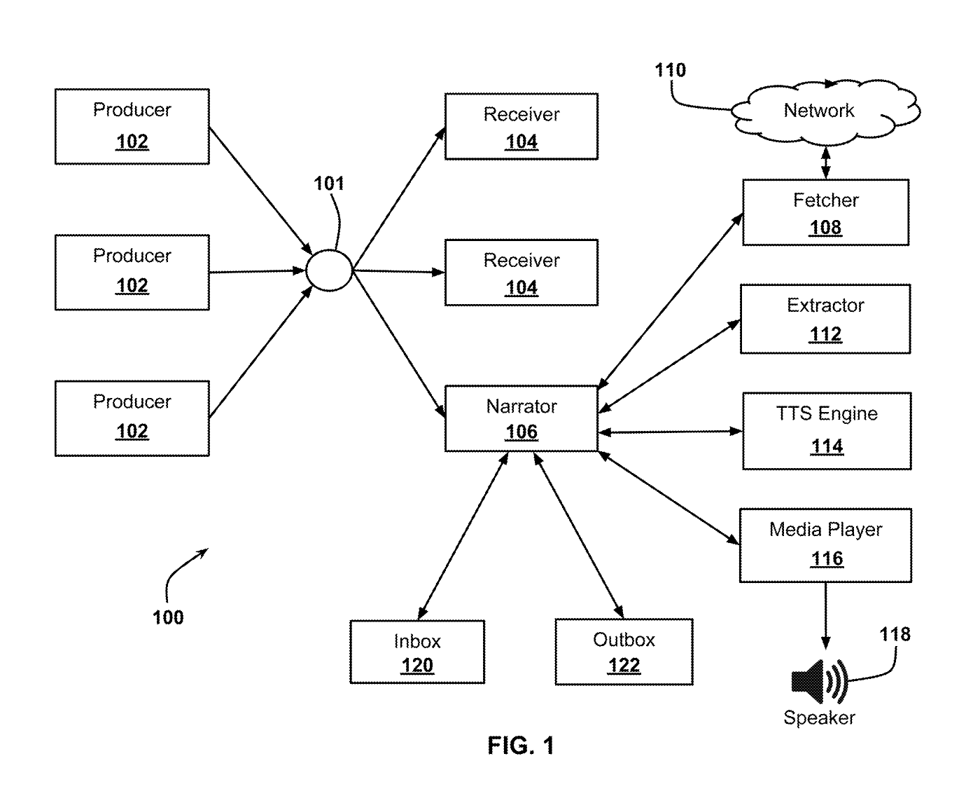

FIG. 1 illustrates one embodiment of a speech augmentation system 100. The system 100 uses a framework 101 for sharing content between applications on a mobile device with an appropriate operating system (e.g., an ANDROID™ device such as a NEXUS 7™ or an iOS™ device such as an iPHONE™ or iPAD™, etc.). More specifically, the framework 101 defines a method for sharing content between two complementary components, namely a producer 102 and a receiver 104. In one embodiment, the framework 101 is comprised of the ANDROID™ Intent Model for inter-application functionality. In another embodiment, the framework 101 is comprised of the Document Interaction Model from iOS™.

The system 100 includes one or more producers 102, which are applications capable of initiating a share action, thus sharing pieces of content with other applications. The system 100 also includes one or more receivers 104, which are applications capable of receiving such pieces of shared content. One type of receiver 104 is a narrator 106, which provides speech functionality to one or more producers 102. It is possible for a single application to have both producer 102 and receiver 104 aspects. The system 100 may include other applications, including, but not limited to, email clients, web browsers, and social networking apps.

Still referring to FIG. 1, the narrator 106 is coupled with a fetcher 108, which is capable of retrieving linked content from the network 110. The fetcher 108 may retrieve linked content via a variety of retrieval methods. In one embodiment, the fetcher 108 is a web browser component that dereferences links in the form of Uniform Resource Locators (URLs) and fetches linked content in the form of HyperText Markup Language (HTML) documents via the HyperText Transfer Protocol (HTTP). The network 110 is typically the Internet, but can be any network, including but not limited to any combination of LAN, MAN, WAN, mobile, wired, wireless, private network, and virtual private network components.

In the embodiment illustrated in FIG. 1, the narrator 106 is coupled with an extractor 112, a TTS engine 114, a media player 116, an inbox 120, and an outbox 122. In other embodiments, the narrator is coupled with different and/or additional elements. In addition, the functions may be distributed among the elements in a different manner than described herein. For example, in one embodiment, playback items are played immediately on generation and are not saved, obviating the need for an inbox 120 and an outbox 122. As another example, the media player 116 may receive audio data for playback directly from the TTS engine 114, rather than via the narrator 106 as illustrated in FIG. 1.

The extractor 112 separates the text that should be spoken from any undesirable markup, boilerplate, or other clutter within shared or linked content. In one embodiment, the extractor 112 accepts linked content, such as an HTML document, from which it extracts text. In another embodiment, the extractor 112 simply receives a link or other addressing information (e.g., a URL) and returns the extracted text. The extractor 112 may employ a variety of extraction techniques, including, but not limited to, tag block recognition, image recognition on rendered documents, and probabilistic block filtering. Finally, it should be noted that the extractor 112 may reside on the mobile device in the form of a software library (e.g., the boilerpipe library for JAVA™) or in the cloud as an external service, accessed via the network 110 (e.g., Diffbot.com).

The TTS engine 114 converts text into a digital audio representation of the text being spoken aloud. This speech audio data may be encoded in a variety of audio encoding formats, including, but not limited to, PCM WAV, MP3, or FLAC. In one embodiment, the TTS Engine 114 is a software library or local service that generates the speech audio data on the mobile device. In other embodiments, the TTS Engine 114 is a remote service (e.g., accessed via the network 110) that returns speech audio data in response to being provided with a chunk of text. Commercial providers of components that could fulfill the role of TTS Engine 114 include Nuance, Inc. of Burlington, Mass., among others.

The media player 116 converts the speech audio data generated by the TTS engine 114 into audible sound waves to be emitted by a speaker 118. In one embodiment, the speaker 118 is a headphone, speaker-phone, or audio amplification system of the mobile device on which the narrator is executing. In another embodiment, the speech audio data is transferred to an external entertainment or sound system for playback. In some embodiments, the media player 116 has playback controls, including controls to play, pause, resume, stop, and seek within a given track of speech audio data.

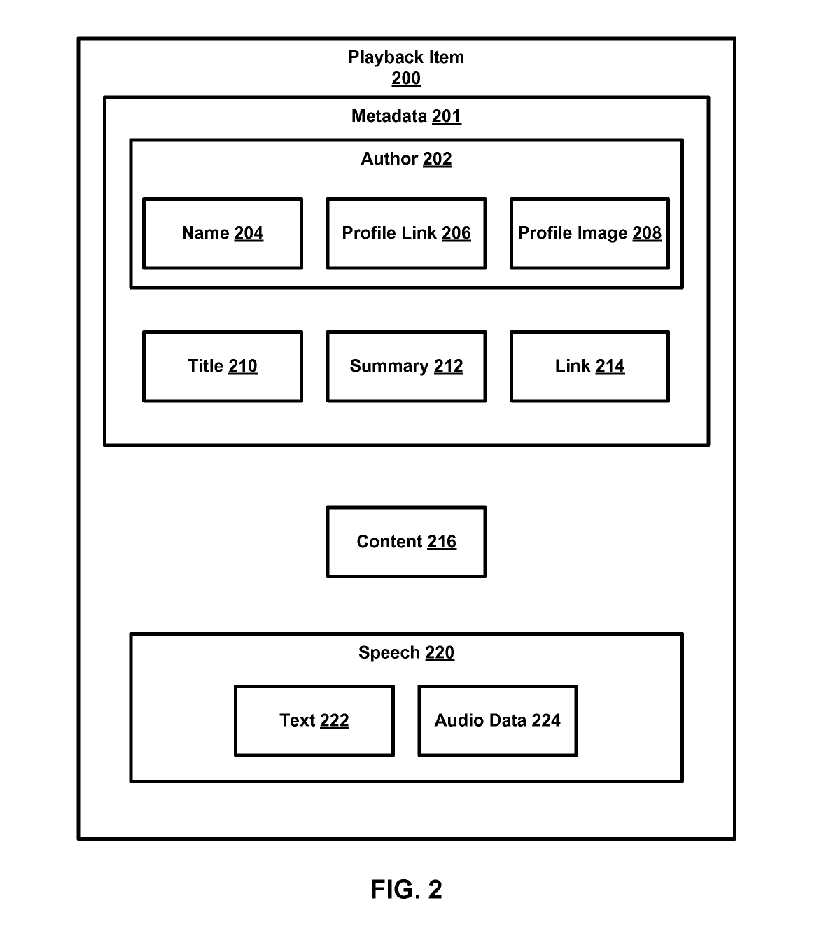

The inbox 120 stores playback items until they are played. The format of playback items is described more fully with respect to FIG. 2. The inbox 120 can be viewed as a playlist of playback items 200 that controls what items are presented to the end user, and in what order playback of those items occurs. In one embodiment, the inbox 120 uses a stack for Last-In-First-Out (LIFO) playback. In other embodiments, other data structures are used, such as a queue for First-In-First-Out (FIFO) playback or a priority queue for ranked playback such that higher priority playback items (e.g., those that are determined to have a high likelihood of value to the user) are outputted before lower priority playback items (e.g., those that are determined to have a low likelihood of value to the user).

The outbox 122 receives playback items after they have been played. Some embodiments automatically transfer a playback item from inbox 120 to outbox 122 once it has been played, while other embodiments require that playback items be explicitly transferred. By placing a playback item in the outbox 120, it will not be played to the end-user again automatically, but the end user can elect to listen to such a playback item again. For example, if the playback item corresponds to directions to a restaurant, the end-user may listen to them once and set off, and on reaching a particular intersection listen to the directions again to ensure the correct route is taken. In one embodiment, the inbox 120 and outbox 122 persist playback items onto the mobile device so that playback items can be accessed with or without a connection to the network 110. In another embodiment, the playback items are stored on a centralized server in the cloud and accessed via the network 110. Yet another embodiment synchronizes playback items between local and remote storage endpoints at regular intervals (e.g., once every five minutes).

### Example Playback Item Data Structure

Turning now to FIG. 2, there is shown the format of a playback item 200, according to one embodiment. In the embodiment shown, the playback item 200 includes metadata 201 providing information about the playback item 200, content 216 received from a producer 102, and speech data 220 generated by the narrator 106. In other embodiments, a playback item 200 contains different and/or additional elements. For example, the metadata 201 and/or content 216 may not be included, making the playback item 200 smaller and thus saving bandwidth.

In FIG. 2, the metadata 201 is shown as including an author 202, a title 210, a summary 212, and a link 214. Some instances of playback item 200 may not include all of this metadata. For example, the profile link 206 may only be included if the identified author 202 has a public profile registered with the system 100. The metadata identifying the author 202 includes the author's name 204 (e.g., a text string for display), a profile link 206 (e.g., a URL that points to information about the author), and a profile image 208 (e.g., an image or avatar selected by the author). In one embodiment, the profile image 208 is cached on the mobile device for immediate access. In another embodiment, the profile image 208 is a URL to an image resource accessible via the network 110.

In one embodiment, the title 210 and summary 212 are manually specified and describe the content 216 in plain text. In other embodiments, the title and/or summary are automatically derived from the content 216 (e.g., via one or more of truncation, keyword analysis, automatic summarization, and the like), or acquired by any other means by which this information can be obtained. Additionally, the playback item 200 shown in FIG. 2 contains a link 214 (e.g., a URL pointing to external content or a file stored locally on the mobile device that provides additional information about the playback item).

In one embodiment, the content 216 includes some or all of the shared content received from a producer 102. The content 216 may also include linked content obtained by fetching the link 214, if available. The speech 220 contains text 222 and audio data 224. The text 222 is a string representation of the content 216 that is to be spoken. The audio data 224 is the result of synthesizing some or all of the text 222 into a digital audio representation (e.g., encoded as a PCM WAV, MP3, or FLAC file).

### Exemplary Methods

In this section, various embodiments of a method for providing dynamic speech functionality for an application are described. Based on these exemplary embodiments, one of skill in the art will recognize that variations to the method may be made without deviating from the spirit and scope of this disclosure. The steps of the exemplary methods are described as being performed by specific components, but in some embodiments steps are performed by different and/or additional components than those described herein. Further, some of the steps may be performed in parallel, or not performed at all, and some embodiments may include different and/or additional steps.

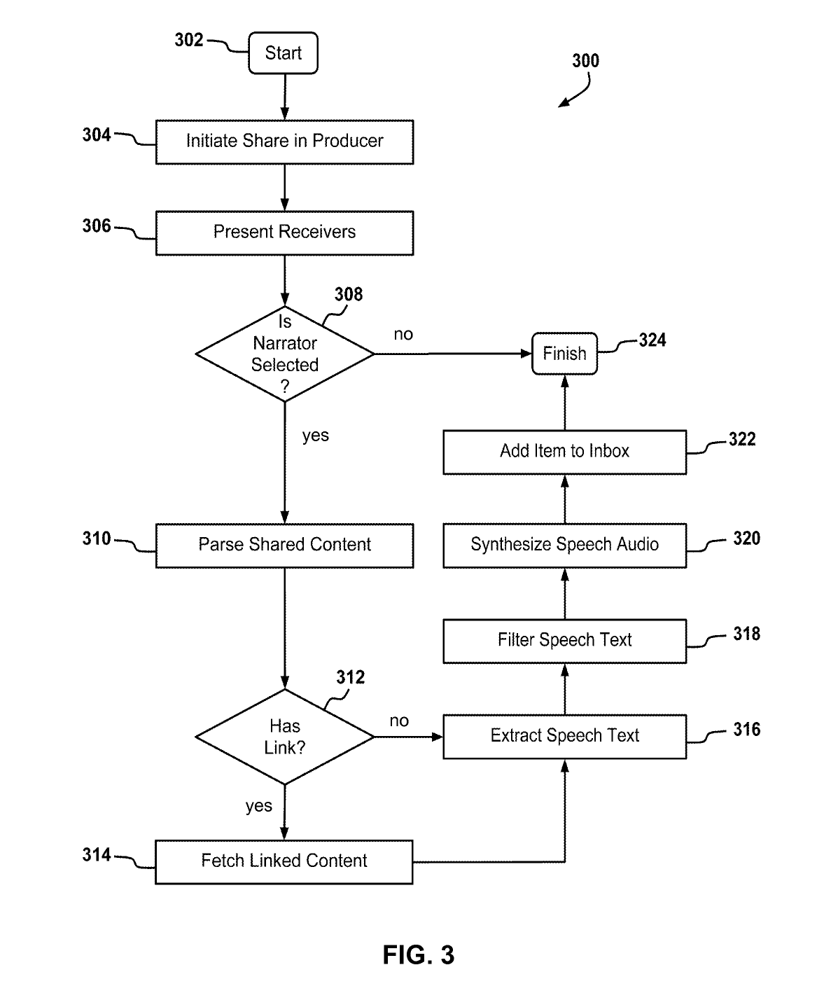

Referring now to FIG. 3, there is shown a playback item creation method 300, according to one embodiment. The steps of FIG. 3 are illustrated from the perspective of system 100 performing the method. However, some or all of the steps may be performed by other entities and/or components. In addition, some embodiments may perform the steps in parallel, perform the steps in different orders, or perform different steps. In one embodiment, the method 300 starts 302 with a producer application 102 running in the foreground of a computing device (e.g., a smartphone). In another embodiment, some producers 102 may cause the method 300 to start 302 while running in the background.

In step 304, the producer application 102 initiates a share action. The share action comprises gathering some amount of content to be shared (“shared content”), within which links to linked content may be embedded. In step 306, a selection of receivers 104 is compiled through a query to the framework 101 and presented. If the narrator 106 is selected (step 308), the shared content is sent to the narrator. If the narrator 106 is not selected, the process 300 terminates at step 324. In one embodiment, the system is configured to automatically provide shared content from certain provider applications 102 to the narrator 106, obviating the need to present a list of receivers and determine whether the narrator is selected.

In step 310, the narrator parses the shared content to construct a playback item 200. In one embodiment, the parsing includes mapping the shared content to a playback item 200 format, such as the one shown in FIG. 2. In other embodiments, different data structures are used to store the result of parsing the shared content.

At step 312, the narrator 106 determines whether the newly constructed playback item 200 includes a link 214. If the newly constructed playback item 200 includes a link, the method 300 proceeds to step 314, and the corresponding linked content is fetched (e.g., using a fetcher 108) and added to the playback item. In one embodiment, the linked content replaces at least part of the shared content as the content 216 portion of the playback item 200.

After the linked content has been fetched, or if there was no linked content in the newly constructed content item 200, the narrator 106 passes the content 216 to the extractor 112 (step 316). The extractor 112 processes the content 216 to extract speech text 222, which corresponds to the portions of the shared content that are to be presented as speech. In step 318, the extracted text 222 is passed through a sequence of one or more filters to make the extracted text more suitable for application of a text-to-speech algorithm, including but not limited to, a filter to remove textual artifacts, a filter to convert common abbreviations into full words, a filter to remove symbols and unpronounceable characters, a filter to convert numbers to phonetic spellings, optionally converting the number 0 into the word “oh”, and a filter to convert acronyms into phonetic spellings of the letters to be said out loud. In one embodiment, specific filters to handle specific foreign languages are used, such as phonetic spelling filters customized for specific languages, translation filters that convert shared content in a first language to text in a second language, and the like. In another embodiment, no filters are used.

In step 320, the narrator 106 passes the extracted (and filtered, if filters are used) text 222 to the TTS engine 114 and the TTS engine synthesizes audio data 224 from the text 222. In one embodiment, the TTS engine 114 saves the audio data 224 as a file, e.g., using a filename derived from a MD5 hash algorithm applied to both the inputted text and any voice settings needed to reproduce the synthesis. In some embodiments, especially those constrained in terms of internet connectivity, RAM, CPU, or battery power, the text 222 is divided into segments and the segments are converted into audio data 224 in sequence. Segmentation may reduce synthesis latency in comparison with other TTS processing techniques.

In step 322, the narrator 106 adds the playback item 200 to the inbox 120. In one embodiment, the playback item 200 includes the metadata 201, content 216, and speech data 220 shown in FIG. 2. In other embodiments, some or all of the elements of the playback item are not saved with the playback item 200 in the inbox 120. For example, the playback item 200 in the inbox 120 may include just the audio data 224 for playback. Once the playback item 200 is added to the inbox 120, the method 300 is complete and can terminate 324, or begin again to generate additional playback items 200.

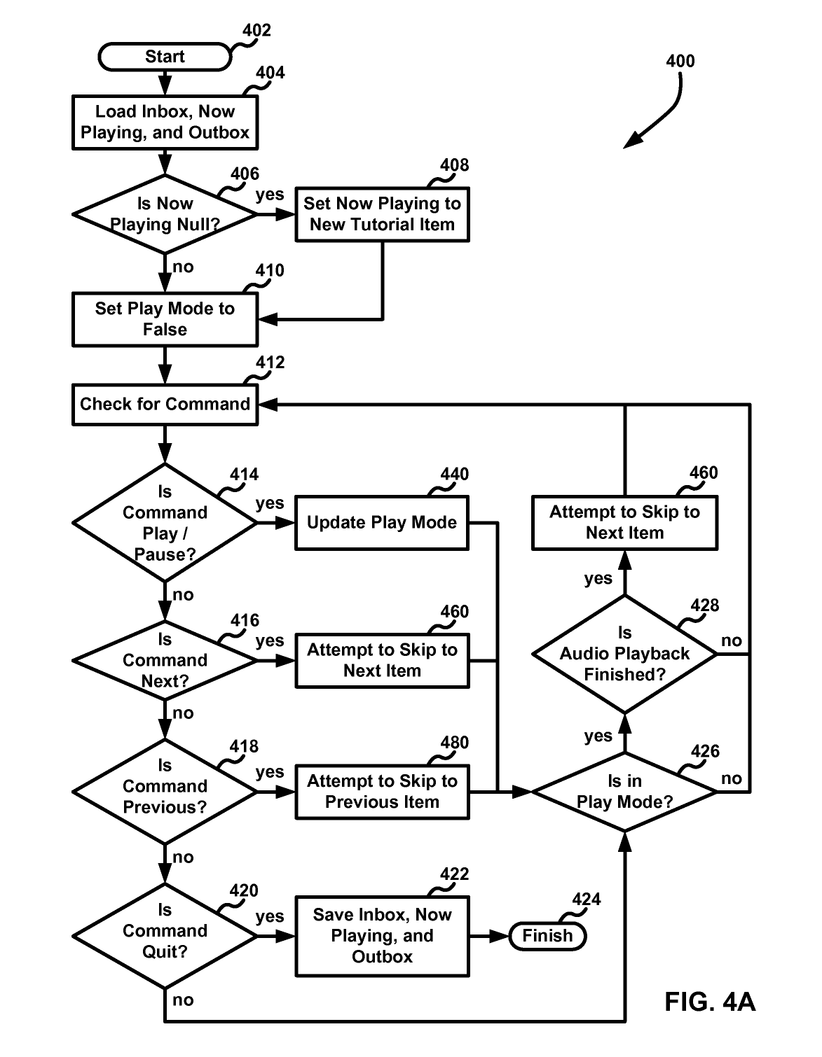

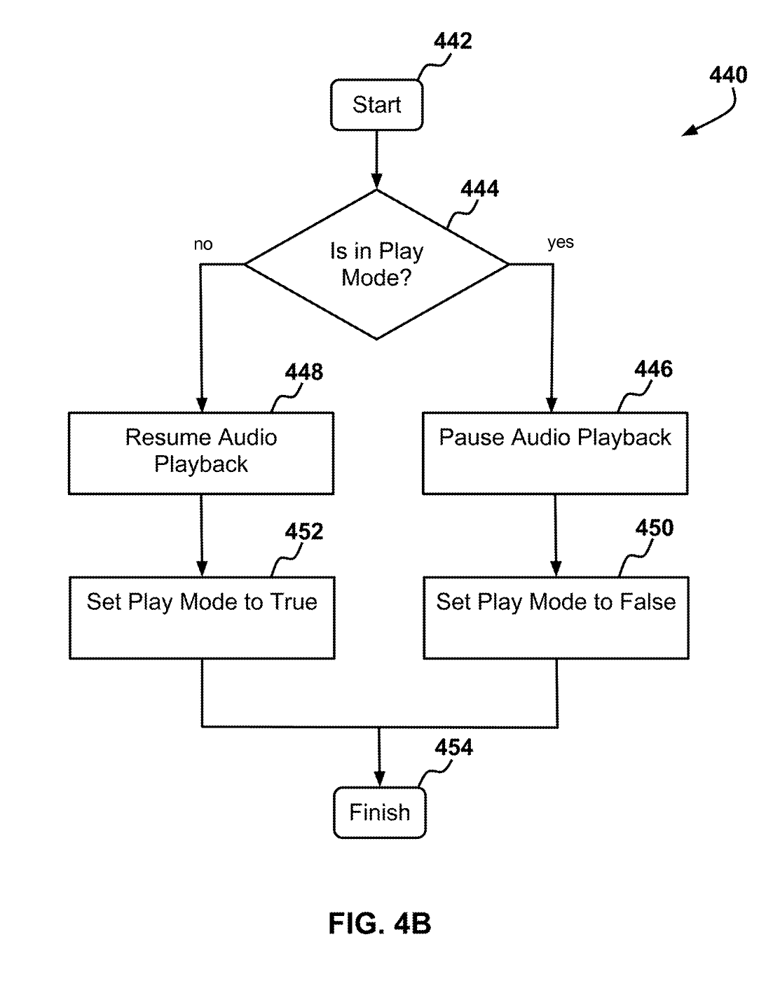

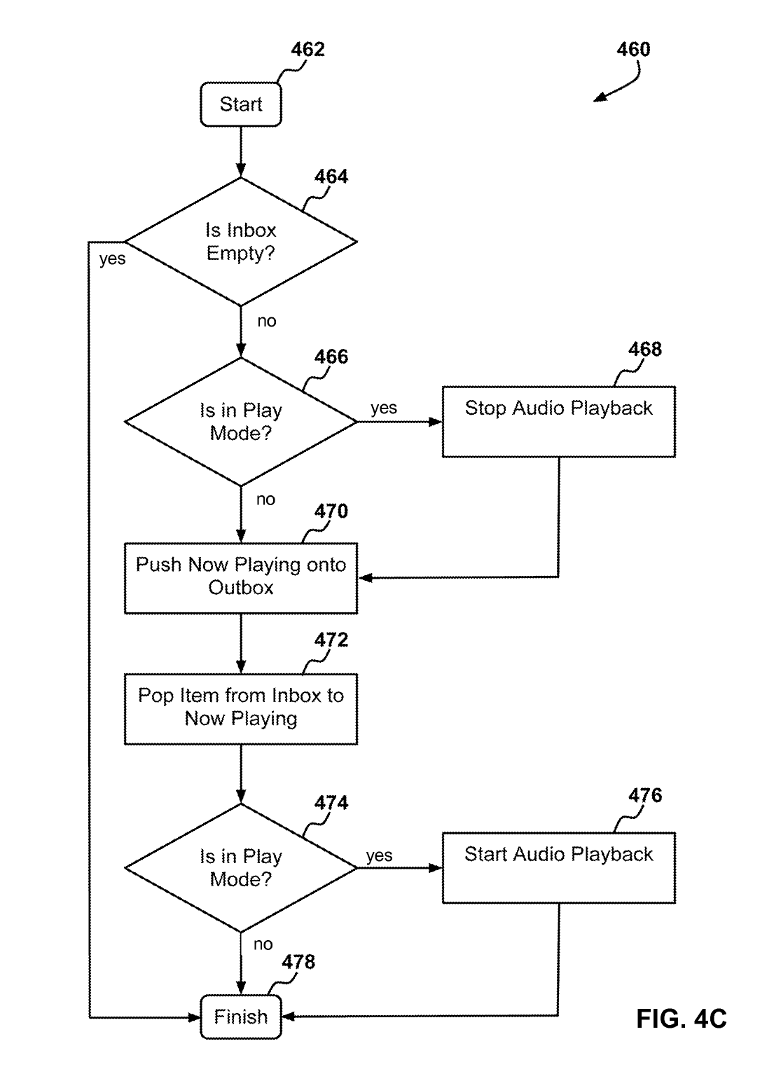

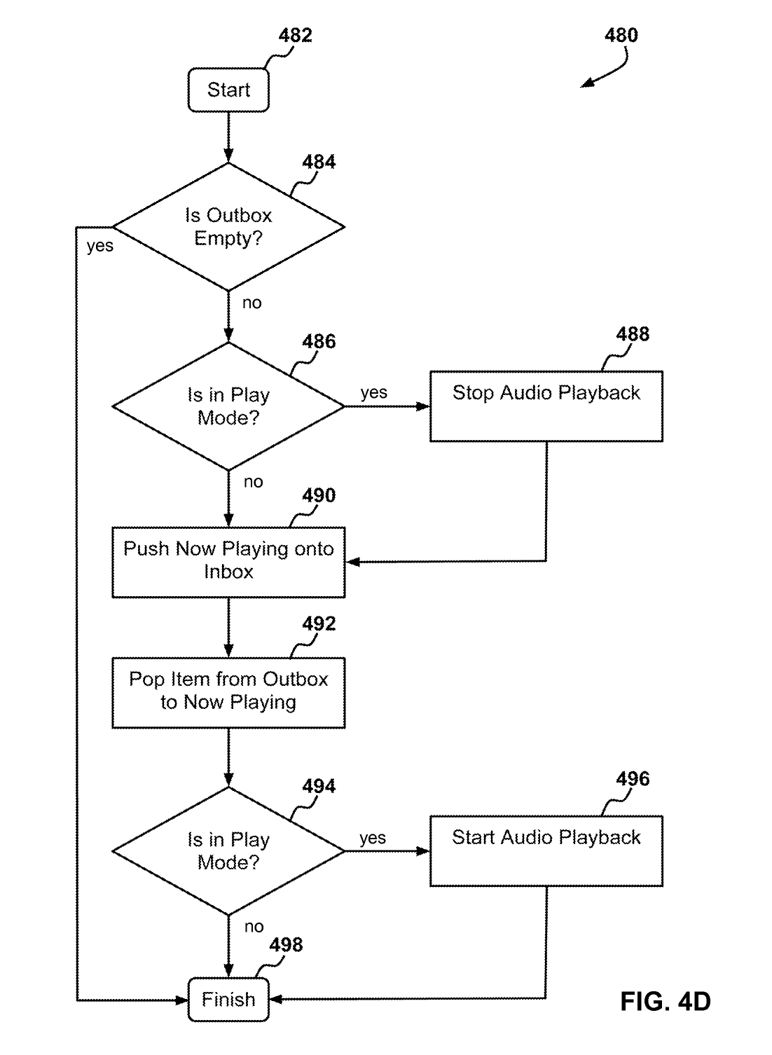

Referring now to FIG. 4A, there is shown a method 400 for playing back playback items in a user's inbox 120, according to one embodiment. The steps of FIG. 4A are illustrated from the perspective of the narrator 106 performing the method. However, some or all of the steps may be performed by other entities and/or components. In addition, some embodiments may perform the steps in parallel, perform the steps in different orders, or perform different steps.

The method 400 starts at step 402 and proceeds to step 404, in which the narrator 106 loads the user's inbox 120, outbox 122, and the current playback item (i.e., the one now playing) into working memory from persistent storage (which may be local, or accessed via the network 110). In one embodiment, if there is not a current playback item, as determined in step 406, the narrator 106 sets a tutorial item describing operation of the system as the current playback item (step 408). In other embodiments, the narrator 106 performs other actions in response to determining that there is not a current playback item, including taking no action at all. In the embodiment shown in FIG. 4A, the narrator 106 initially sets the play mode to false at step 410, meaning no playback items are yet to be vocalized. In another embodiment, the narrator 106 sets playback to true on launch, meaning playback begins automatically.

In step 412, the narrator application 106 checks for a command issued by the user. In one embodiment, if no command has been provided by the user, the narrator application 106 generates a “no command received” pseudo-command item, and the method 400 proceeds by analyzing this pseudo-command item. Alternatively, the narrator application 106 may wait for a command to be received before the method 400 proceeds. In one embodiment, the commands available to the end user include play, pause, next, previous, and quit. A command may be triggered by a button click, a kinetic motion of the computing device on which the narrator 106 is running, a swipe on a touch surface of the computing device, a vocally spoken command, or by other means. In other embodiments, different and/or additional commands are available to the user.

At step 414, if there is a command to either play or pause playback, the narrator 106 updates the play mode as per process 440, one embodiment of which is shown in greater detail in FIG. 4B. Else, if there is a command to skip to the next playback item, as detected at step 416, narrator 106 implements the skip forward process 460, one embodiment of which is shown in greater detail in FIG. 4C. Else, if a command to skip to the previous playback item is detected at step 418, the narrator 106 implements the skip back process 480, one embodiment of which is shown in greater detail in FIG. 4D. After implementation of each of these processes (440, 460, and 480) the method 400 proceeds to step 426. If there is no command (e.g., if a “no command received” pseudo-command item was generated), the method 400 continues on to step 426 without further action being taken. However, if a quit command is detected at step 420, the narrator application 106 saves the inbox 120, outbox 122, and the current playback item in step 422 and the method 400 terminates (step 424).

At step 426, the narrator 106 determines if play mode is currently enabled (e.g., if play mode is set to true). If the narrator is not in play mode, the method 400 returns to step 412 and the narrator 106 checks for a new command from the user. If the narrator 106 is in play mode, the method 400 continues on to step 428, where the narrator 106 determines if the media player 116 has finished playing the current playback item's audio data 224. If the media player 116 has not completed playback of the current playback item, playback continues and the method 400 returns to step 412 to check for a new command from the user. If the media player 116 has completed playback of the current playback item, the narrator 106 attempts to move on to a next playback item by implementing process 460, an embodiment of which is shown in FIG. 4C. Once the skip has been attempted, the method 400 loops back to step 412 and checks for a new command from the user.

Referring now to FIG. 4B, there is shown a play mode update process 440, previously mentioned in the context of FIG. 4A, according to one embodiment. The steps of FIG. 4B are illustrated from the perspective of the narrator 106 performing the process 440. However, some or all of the steps may be performed by other entities and/or components. In addition, some embodiments may perform the steps in parallel, perform the steps in different orders, or perform different steps.

The process 440 starts at step 442. At step 444 the narrator 106 determines whether it is currently in play mode (e.g., is a play mode parameter of the narrator currently set to true). If the narrator 106 is in play mode, meaning that playback items are currently being presented to the user, the narrator changes to a pause mode. In one embodiment, this is done by pausing the media player 116 (step 446) and setting the play mode parameter of the narrator 106 to false (step 450). On the other hand, if the narrator 106 determines at step 444 that it is currently not in play mode (e.g., if the narrator is in a pause mode), the narrator is placed into the play mode. In one embodiment, this is done by instructing the media player 116 to begin/resume playback of the current playback item's audio data 224 (step 448) and the play mode parameter is set to true (step 452). Once the play mode has been updated, the process 440 ends (step 454) and control is returned to the calling process, e.g., method 400 shown in FIG. 4A.

Referring now to FIG. 4C, there is shown a skip forward process 460, previously mentioned in the context of FIG. 4A, according to one embodiment. The steps of FIG. 4C are illustrated from the perspective of the narrator 106 performing the process 460. However, some or all of the steps may be performed by other entities and/or components. In addition, some embodiments may perform the steps in parallel, perform the steps in different orders, or perform different steps.

The process 460 starts out at step 462 and proceeds to step 464. At step 464, the narrator 106 determines whether the inbox 120 is empty. If the inbox 120 is empty, the process 460 ends (step 478) since there is no playback item to skip forward to, and control is returned to the calling process, e.g., method 400 shown in FIG. 4A. If there is an available playback item in the inbox 120, the narrator 106 determines whether it is currently in play mode (step 466). If the narrator 106 is in play mode, the narrator interrupts playback of the current playback item by the media player 116 (step 468) and the process 460 proceeds to step 470. If the narrator 106 is not in play mode, the process 460 proceeds directly to step 470. In one embodiment, inbox 120 and outbox 122 are stacks stored in local memory and step 470 comprises the narrator 106 pushing the current playback item onto the stack corresponding to outbox 122, while step 472 comprises the narrator popping a playback item from the inbox to become the current playback item.

In step 474, another determination is made as to whether the narrator 106 is in play mode. If the narrator 106 is in play mode, the media player 116 begins playback of the new current playback item (step 476) and the process 460 terminates (step 478), returning control to the calling process, e.g., method 400 shown in FIG. 4A. If the narrator 106 is not in play mode, the process 460 terminates without beginning audio playback of the new current playback item.

Referring now to FIG. 4D, there is shown a skip backward process 480, according to one embodiment. The steps of FIG. 4D are illustrated from the perspective of the narrator 106 performing the process 480. However, some or all of the steps may be performed by other entities and/or components. In addition, some embodiments may perform the steps in parallel, perform the steps in different orders, or perform different steps. The process 480 is logically similar to the process 460 of FIG. 4C. For the sake of completeness, process 480 is described in similar terms as process 460.

Process 480 starts at step 482 and proceeds to step 484. At step 484, the narrator 106 determines whether the outbox 122 is empty. If the outbox is empty, the process 480 returns control to process 400 at step 498 since there is no item to skip towards. In contrast, if the narrator 106 determines that there is an available item in the outbox 122, the narrator checks to see if the play mode is currently enabled (step 486). If the narrator 106 is currently in play mode, playback of the current item is interrupted (step 488) and the process 480 proceeds to step 490. If the narrator 106 is not in play mode, the process 480 proceeds directly to step 490. In one embodiment, the inbox 120 and the outbox 122 are stacks stored in local memory and step 490 comprises the narrator 106 pushing the current item onto the stack corresponding to the inbox 120, while step 492 comprises the narrator popping a playback item from the outbox 122 stack to become the current playback item.

In step 494, another determination is made as to whether the narrator 106 is in play mode. If the narrator 106 is in play mode, the media player 116 begins playback of the new current playback item (step 496) and the process 480 terminates (step 498), returning control to the calling process, e.g., method 400 shown in FIG. 4A. If the narrator 106 is not in play mode, the process 480 terminates without beginning audio playback of the new current playback item.

### Computing Machine Architecture

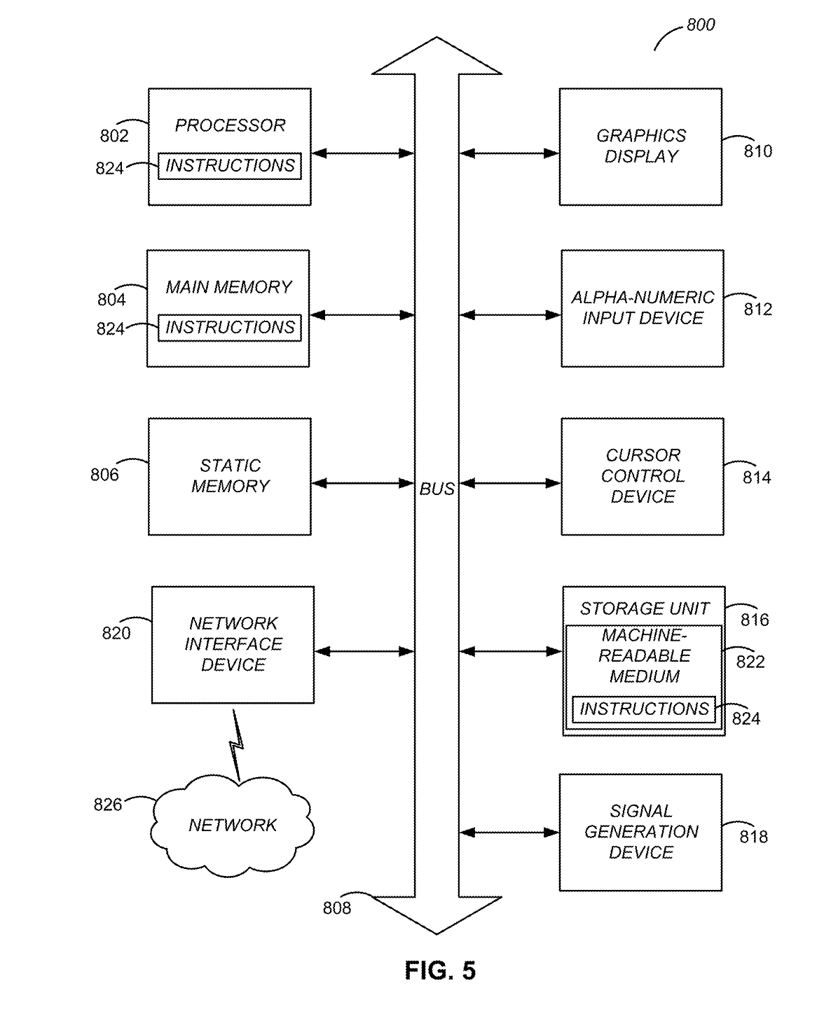

FIG. 5 is a block diagram illustrating components of an example machine able to read instructions from a machine-readable medium and execute them in a processor (or controller). Specifically, FIG. 5 shows a diagrammatic representation of a machine in the example form of a computer system 800 within which instructions 824 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media, and other non-transitory storage media.

It is to be understood that the above described embodiments are merely illustrative of numerous and varied other embodiments which may constitute applications of the principles of the disclosure. Such other embodiments may be readily devised by those skilled in the art without departing from the spirit or scope of this disclosure.

### Additional Configuration Considerations

The disclosed embodiments provide various advantages over existing systems that provide speech functionality. These benefits and advantages include being able to provide speech functionality to any application that can output data, regardless of that application's internal operation. Thus, application developers need not consider how to implement speech functionality during development. In fact, the embodiments disclosed herein can dynamically provide speech functionality to applications without the deverlopers of those applications considering providing speech functionality at all. For example, an application that is designed to provide text output on the screen of a mobile device can be supplemented with dyanamic speech functionality without making any modifications to the original application. Other advantages include enabling the end-user to control when and how many items are presented to them, providing efficient filtering of content not suitable for speech output, and prioritizing output items such that those of greater interest/importance to the end user are presented before those of lesser interest/importance. One of skill in the art will recognize additional features and advantages of the embodiments presented herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for providing dynamic speech augmentation to mobile applications through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A system that dynamically provides speech functionality to one or more applications, the system comprising:
a narrator configured to receive a plurality of shared data items from the one or more applications, each shared data item comprising text data to be presented to a user as speech;
an extractor, operably coupled to the narrator, configured to extract the text data from each shared data item, thereby producing a plurality of playback data items;
a text-to-speech engine, operably coupled to the extractor, configured to apply a text-to-speech algorithm to the playback data items, thereby producing a plurality of audio data items;
an inbox, operably coupled to the text-to-speech-engine, configured to store the plurality of audio data items and in indication of a playback order; and
a media player, operably connected to the inbox, configured to play the plurality of audio data items in the playback order.

2. The system of claim 1, wherein extracting the text data comprises applying at least one technique selected from the group consisting of: tag block recognition, image recognition on rendered documents, and probabilistic block filtering.

3. The system of claim 1, wherein the extractor is further configured to apply one or more filters to the text data, the one or more filters making the playback data items more suitable for application of the text-to-speech algorithm.

4. The system of claim 3, wherein the one or more filters comprise at least one filter selected from the group consisting of: a filter to remove textual artifacts, a filter to convert common abbreviations into full words; a filter to remove unpronounceable characters; a filter to convert numbers to phonetic spellings; a filter to convert acronyms into phonetic spellings of the letters to be said out loud; and a filter to translate the playback data from a first language to a second language.

5. The system of claim 1, wherein a first subset of the plurality of shared data items are received from a first application and a second subset of the plurality of shared data items are received from a second application, the second application different than the first application.

6. The system of claim 1, further comprising an outbox configured to store audio data items after the audio data items have been played, the media player further configured to provide controls enabling the user to replay one or more of the audio data items.

7. The system of claim 1, wherein the inbox is further configured to determine a priority for an audio data item, the priority indicating a likelihood that the audio data item will be of value to the user, the position of the audio data item in the playback order based on the priority.

8. A system that dynamically provides speech functionality to an application, the system comprising:
a narrator configured to receive shared data from the application, the shared data comprising text data to be presented to a user as speech;
an extractor, operably coupled to the narrator, configured to extract the text data from the shared data;
a text-to-speech engine, operably coupled to the extractor, configured to apply a text-to-speech algorithm to the text data, thereby producing an audio data item; and
a media player configured to play the audio data item.

9. The system of claim 8, further comprising:
an inbox, operably coupled to the text-to-speech-engine, configured to add the audio data item to a playlist, the playlist comprising a plurality of audio data items, an order of the plurality of audio data items based on at least one of: an order in which the plurality of audio data items were received; and priorities of the audio playback items.

10. The system of claim 8, wherein the text data includes a link to external content, the system further comprising:
a fetcher, operably coupled to the narrator, configured to fetch the external content and add the external content to the text data.

11. A method of dynamically providing speech functionality to one or more applications, comprising:
receiving a plurality of shared data items from the one or more applications, each shared data item comprising text data to be presented to a user as speech;
extracting the text data from each shared data item, thereby producing a plurality of playback data items;
applying a text-to-speech algorithm to the playback data items, thereby producing a plurality of audio data items; and
playing the plurality of audio data items.

12. The method of claim 11, wherein extracting the text data comprises applying at least one technique selected from the group consisting of: tag block recognition, image recognition on rendered documents, and probabilistic block filtering.

13. The method of claim 11, further comprising applying one or more filters to the text data, the one or more filters making the playback data items more suitable for application of the text-to-speech algorithm.

14. The method of claim 13, wherein the one or more filters comprise at least one filter selected from the group consisting of: a filter to remove textual artifacts, a filter to convert common abbreviations into full words; a filter to remove unpronounceable characters; a filter to convert numbers to phonetic spellings; a filter to convert acronyms into phonetic spellings of the letters to be said out loud; and a filter to translate the playback data from a first language to a second language.

15. The method of claim 11, wherein a first subset of the plurality of shared data items are received from a first application and a second subset of the plurality of shared data items are received from a second application, the second application different than the first application.

16. The method of claim 11, further comprising:
adding audio data items to an outbox after the audio data items have been played; and
providing controls enabling the user to replay one or more of the audio data items.

17. The method of claim 11, further comprising:
determining a playback order for the plurality of audio data items, the playback order based on at least one of: an order in which the plurality of playback items were received; and priorities of the audio playback items.

18. A non-transitory computer readable medium configured to store instructions for providing speech functionality to an application, the instructions when executed by at least one processor cause the at least one processor to:
receive shared data from the application, the shared data comprising playback data to be presented to a user as speech;
create a playback item based on the shared data, the playback item comprising text data corresponding to the playback data;
apply a text-to-speech algorithm to the text data to generate playback audio; and
play the playback audio.

19. The non-transitory computer readable medium of claim 18, wherein the instructions further comprise instructions that cause the at least one processor to:
add the audio data item to a playlist, the playlist comprising a plurality of audio data items, an order of the plurality of audio data items based on at least one of: an order in which the plurality of audio data items were received; and priorities of the audio playback items.

20. The non-transitory computer readable medium of claim 18, wherein the playback data includes a link to external content, the instructions further comprising instructions that cause the at least one processor to:
fetch the external content and add the external content to the text data.
